(19) United States
(12) Patent Application Publication
(10) Pub. No.: US 2016/0210649 A1
(43) Pub. Date: Jul. 21, 2016

(54) Communications Brokering System

(71) Applicants: Ryan Buckholdt, Santa Cruz, CA (US); Bernice Brubeck Wong, Santa Cruz, CA (US); John Derek Spagnola, Corralitos, CA (US); Jiro Wise Wiseman, Watsonville, CA (US)

(72) Inventors: Ryan Buckholdt, Santa Cruz, CA (US); Bernice Brubeck Wong, Santa Cruz, CA (US); John Derek Spagnola, Corralitos, CA (US); Jiro Wise Wiseman, Watsonville, CA (US)

(21) Appl. No.: 14/600,936

(22) Filed: Jan. 20, 2015

(51) Int. Cl. G06Q 30/02; G06Q 50/00; H04L 29/08

(52) U.S. Cl. CPC G06Q 30/0214; H04L 67/02; H04L 67/327; H04L 67/306; H04L 67/2814; G06Q 50/01

(57) ABSTRACT

A communications broker includes a network-connected server having a processor and a data repository and software executing from the processor and providing a network connection between at least one network-connected appliance hosting source data and the server, a data search function returning data for service to the at least one network-connected appliance based on collected information including information gained from consumer selection of multiple presented images, a referral network function identifying clients of the communications broker, consumers directed to client URLs, and tracking events that are subject to fee disbursement upon transaction occurrence, and a routing function routing calls placed by the consumers to numbers provided by the broker, the calls including identifying indicia, the numbers virtual numbers associated with actual contact representative numbers, the actual numbers matched to the called numbers in routing, the indicia identifying products or services and the contact representative numbers.

### CROSS-REFERENCE TO RELATED DOCUMENTS

[TBD]

### BACKGROUND OF THE INVENTION

1. Field of the Invention

The present invention is in the field of telephony including Internet protocol network telephony (IPNT) and pertains particularly to methods and apparatus for brokering communications relative to potential transactions between two or more parties.

2. Discussion of the State of the Art

In the art of telephony communications in general, network-based communications have become relatively seamless across both digital and plain old telephony (POT) networks. Calls and media may be transmitted through and across disparate but connected networks due to gateway terminals enhanced with media transformation capabilities. As a result, the amount of transaction business relative to private industries and their consumer or market bases conducted over a wide area network, such as the Internet with communications support across disparate networks is ever increasing.

Many transactions performed over a network such as the Internet network for example begin with lengthy processes including populating electronic forms and attempting to communicate through tailored search engines what they are looking for in the way of product. For example, a real estate Website may have an electronic search engine interface for consumers to search for the type of properties they are looking to buy. Likewise, there are consumers Websites that allow consumers to search for products offered by different vendors on a single site. Consumers may browse by category or enter search terms to navigate to areas of the site displaying those products.

Still as more and more selections become available more time is required for the consumer to articulate what they want. The time it takes to get good results may be discouraging for consumers and may lead them to abort the process or compromise to an extent on what they originally were seeking.

Tracking consumer activity and accounting for referral fees or broker commissions may also part of the transaction process. Current systems perform accounting of revenues and referral fees but these processes are performed well after the activity has occurred in many instances and actual data of accounting may not be available to referees or commission recipients for a period of time.

Therefore, what is clearly needed is a communications brokering system that streamlines the process of returning data to consumers that meets consumer requirements and tracks contacts and accounts for referral and other fee disbursements in real time notifying vendors at the time of consumer interactions with their services.

### SUMMARY OF THE INVENTION

In an embodiment of the present invention, an automated communications broker is provided and includes a server connected to the network the server including a processor and at least one data repository and software executing from a non-transitory medium on the processor, the software providing a network connection between at least one network-connected appliance hosting source data and the server, a data search function returning data for service to the at least one network-connected appliance based on collected information including information gained from consumer selection of multiple presented images, a referral network function identifying clients of the communications broker, consumers navigating from client URLs, and tracking events that are subject to fee disbursement upon transaction occurrence, and a routing function routing calls placed by the consumers to numbers provided by the broker, the calls including unique identifying indicia associated to each call, the numbers virtual numbers representing the actual contact representative numbers, the actual numbers matched to the called numbers within the routing process, the indicia identifying products or services and the contact representative numbers.

In one embodiment, the network includes the Internet network and any connected communications networks. In one embodiment, the presented images are pre-selected images that may be associated with text inquiries, the images served to the hosting appliance of the data source from which data is to be collected. In one embodiment, at least the aggregate of the data associated with the consumer-selected images is used to form a data search profile for the consumer operating the appliance hosting the source data. In this embodiment, the search profile is leveraged to initiate a data search of one or more databases on behalf of the consumer.

In one embodiment, the referral network function registers one or more uniquely identified clients to the network, the clients referring consumers to marketed products or services and receiving from the transaction broker a universal resource locator (URL) unique to the client for consumer direction. In this embodiment, the referral network function includes an activity monitor, monitoring consumer attempts to contact a vendor from a client URL using a service engineered contact option. In one embodiment, the routing function generates a call destination path at the router based on matching a virtual contact number given to the consumer to a destination contact number associated with the vendor responsible for servicing the items/services subject to the request. In this embodiment, the routing function includes a voice prompt to the vendor rep or agent of the call, the voice prompt transparent to the consumer in the form of a prompt requesting confirmation of payment of a referral or other fee due to the client upon conclusion of a transaction.

In another embodiment of the invention, a system collecting data from a data source connected to a network and serving media including text results and contact links back to a hosting appliance of the data source or to a another communications endpoint is provided and includes a server connected to the network the server having a processor and at least one data repository coupled thereto and software executing from a non-transitory medium on the server the software providing, serving over the network of one or more pre-selected images and associated text to the hosting appliance of the data source from which data is to be collected, collection of data from the data source, the data pointing to tags indicative of any of the served images selected through computer input methods, identification of tagged images, lookup of additional data pre-associated with the tagged images, formation of a data search profile from the aggregate of the data, leveraging of the search profile to initiate a data search of one or more databases, and serving the results of the data search including images, text, and links to the hosting appliance of the data source or to the other destination.

In one embodiment, the network is the Internet network. In one embodiment, the served images depict pre-documented features or attributes directly or indirectly associated with a product and or service the consumer is interested in. In one embodiment, the associated text includes at least one question with a text input field for accepting typed input for an answer.

According to yet another embodiment of the present invention, a network-based referral system is provided and includes a server connected to the network the server having a processor and at least one data repository coupled thereto and software executing from a non-transitory medium on the processor, the software providing, qualification of one or more user-referring clients to be included in a pool, generation of unique identification in the form of a universal resource locator (URL) for each qualified client in the pool, storing the client URLs in a referral database along with vendor information, identifying a client URL used by a consumer in navigation, the consumer browsing a search result list compiled previously and based on collected input from the one or more consumers, monitoring consumer activity and listening for browser-based execution of a vendor contact attempt, upon contact initiation, record the contact event data, notify client of the contact event, route consumer request, prompt vendor to pay referral fee to the client, upon agreement from the vendor to pay the referral fee, connect the consumer to the vendor in session.

In one embodiment, the network is the Internet network. In one embodiment, the client is notified of a contact attempt associated with a client URL through email, messaging, or a post to a client accessible URL.

In another embodiment of the present invention, a system tracking leads over a telecommunications infrastructure is provided and includes a server connected to the network the server including a processor and at least one data repository and software executing from a non-transitory medium on the processor, the software providing, monitoring of consumer activity at a vendor site, the consumer arriving at the site as a result of execution of a client distributed URL identifying the client to the system, detection of a request for live contact directed to a content database, generation of a unique identifier and a virtual phone number for the consumer to use to dial for service, the unique identifier providing identification of a product or service subject of the requested contact event and the virtual telephone number matched in storage to an actual contact number associated with a representative charged with servicing inquiries about the product or service subject of the request, serving the unique identifier and virtual phone number to a communications switch or router and to the user end device used to access the client URL, and displaying the data on the user's device screen, generating a destination path at the router based on the unique identifier and match of the generated telephone number to the representative contact number, upon dial of the generated number by the user, answering, prompting for, and recording the user's spoken name and spoken or touch tone input of the identifier, sending the contact event data to the server, matching the called number to the telephone number of the appropriate product or service representative and routing the call accordingly, upon answer of the routed call, prompting the representative to agree to pay a fee prior to connecting the representative to the waiting consumer, connecting the consumer to the identified representative contingent upon agreement to pay a referral fee if there is a transaction, recording the connected session and storing the event data in the content database, and serving or otherwise sending electronically, the contact event data back to the client for their records.

In one embodiment, the network is the Internet network. In one embodiment, the client URL is previously assigned to the client and locates a website owned or otherwise controlled by the system. In one embodiment, the client URL is distributed to potential consumers being referred by the vetted client.

### BRIEF DESCRIPTION OF THE DRAWING FIGURES

FIG. 1 is an architectural overview of a communications network supporting brokered communications according to an embodiment of the present invention.

FIG. 2 is a sequence diagram depicting interaction between a user and system components relative to building a search profile for the user.

FIG. 3 is an exemplary screen shot of a user interface for quizzing a user in building a search profile to search for available homes at a real estate website.

FIG. 4 is an exemplary screen shot of another view and state of the interface of FIG. 3

FIG. 5 is an exemplary screen shot of an interface presenting search results organized according to user preferences.

FIG. 6 is a sequence diagram depicting interaction between a user and system components relative to tracking and routing a user inquiry into a product or service.

FIG. 7 is a process flow chart depicting steps for tracking a user and brokering communications on behalf of the user.

### DETAILED DESCRIPTION

The inventors provide a communications brokering system that customizes search results for users, brokers the transaction process for users, and tracks referral, commission, or other fees payable to clients referring users to vendor products and services. The present invention will be described in enabling detail using the following examples, which may describe more than one relevant embodiment falling within the scope of the present invention.

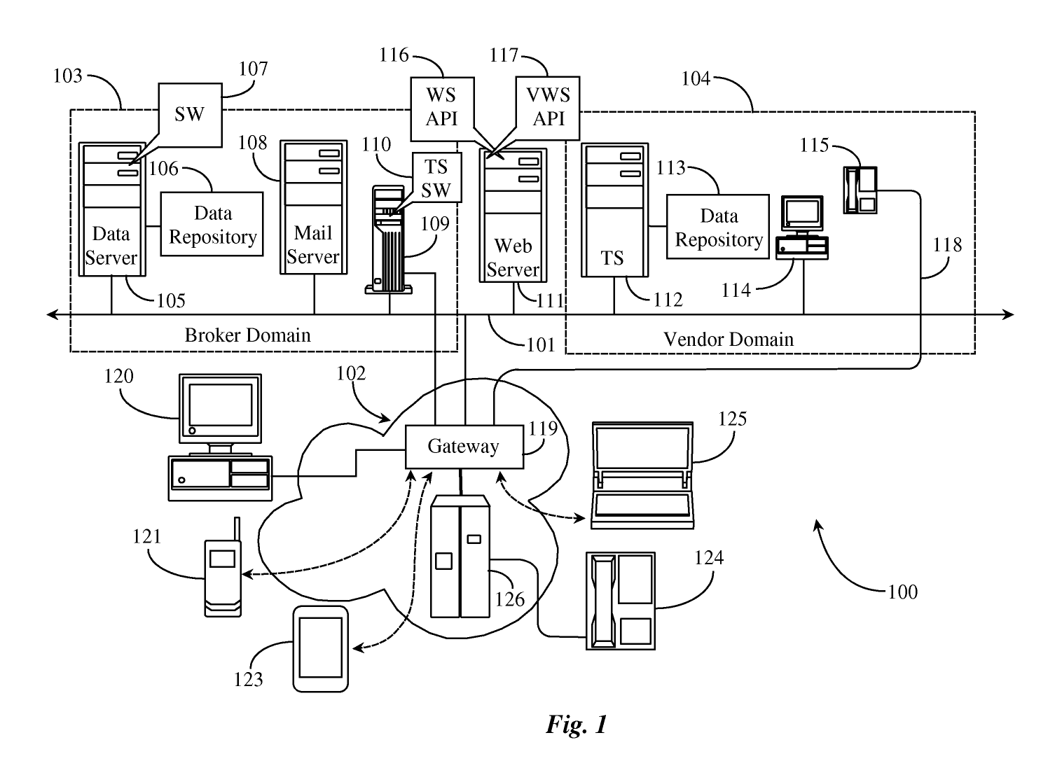

FIG. 1 is an architectural overview of a communications network 100 supporting brokered communications according to an embodiment of the present invention. Communications network 100 includes the well known Internet network represented herein by an Internet backbone 101. Internet backbone 101 represents all of the lines, equipment, and access points that make up the Internet network as a whole including connected sub-networks. Therefore, there are no geographic limitations to the practice of the present invention. Network 101 may be a corporate wide area network (WAN) or a municipal area network (MAN) without departing from the spirit and scope of the present invention.

Communications network 100 includes a communications carrier network 102.

Network 102 may be a wireless carrier network or any other wired or wireless sub-network of Internet 101. Carrier network 102 provides communications and access to Internet network 101 through a communications and media gateway 119. Gateway 119 includes a processor and memory containing thereon all of the software and instruction required to function as a seamless multi-media network gateway according to embodiments of the present invention.

Internet backbone 101 supports a broker domain 103. Broker domain 103 represents a service provider hosting communications brokering including lead or referral tracking as a service to consumers and clients that refer users. In one example, a vendor might be someone selling a home. A client may be a real estate agent or a client in a related field. A user (consumer) may be someone looking for a home. Domain 103 includes a data server 105. Data server 105 includes a processor and a memory containing thereon all of the software and instruction required to function as a data server accepting requests, retrieving stored data and serving the data over the network.

Broker domain 103 may also be referred to hereinafter as a provider domain or simply as provider 103. Provider 103 may provide access to services through a Web server 111 hosting websites accessible to consumers browsing the Internet network. Web server 111 includes a processor and a memory containing thereon all of the software and instruction required to function as a web server serving information pages (websites) to requesting consumers.

In one embodiment, users access provider domain 103 through a website 116. Website 116 includes at least one application program interface (API) relative to SW 107 resident on data server 105 within domain 103. Consumers are represented herein as network-capable computing and communications appliances connected to gateway 119 and or to a local telephony switch 126. Consumer 120 (desktop) is connected to gateway 119 via an Internet access line. Consumer 121 (cell phone) is connected to gateway 119 via a wireless connection. Consumer 123 (android device) is connected to gateway 119 via a wireless connection. Consumer 124 is connected to local telephone switch 126, in turn, connected to gateway 119. Consumer 125 (laptop) is connected to gateway 119 via a wireless connection.

Local telephone switch 126 has access to gateway 119 via a telephony trunk. Consumer 124 is using telephone 124 to call a number provided by the service provider to access a vendor representative after responding to a contact link using a network capable appliance such as a computer or tablet device. More detail tracking communications across multiple communications or access appliances is described in detail later in this specification.

Internet backbone 101 supports a vendor domain 104. Vendor domain 104 may represent a seller of products and or services. A vendor may be any business that allows its products and or services to be represented for acquisition in a third-party environment. A third party environment may be a website that presents products from multiple vendors to consumers. A vendor may have a vendor website (VWS) 117 that includes transaction services and consumer directed help with products and services available through the site. In one embodiment, provider 103 qualifies products and services offered by different vendors and provides consumer access to those products and services through a vendor-assigned website hosted by the provider. In another embodiment a vendor website is enhanced with an application program interface (API) to SW 107 resident on server 105 in the provider domain 103.

In one embodiment of the present invention a vendor is a business or company that offers multiple products and or services. In another embodiment a vendor is a private individual having one or more products or services available for sale. In one example, the owner of one or more properties for sale might be classified as a vendor where a third party representative might be a listing agent. In such a case, the vendor may not have a website but may use a third party like communications broker 103 to list the properties of the vendor for consumer access. A real estate website might be hosted by the service provider in this case. Other vendors may have full Internet presence but also offer products and services through third-party websites and pay referral fees to agents advertising and showing the properties to potential buyers.

In this example, vendor domain 104 includes a transaction server (TS) 112. Transaction server 112 includes a processor at least one data repository coupled thereto and a memory containing all of the software and instruction required to function as a transaction server conducting transactions and accepting payment for goods and services transacted. Transaction server 112 includes a data repository 113 containing data relevant to the business such as product and service data, consumer order, contact and billing data, help information, and any other data deemed relevant and critical for doing business. Vendor domain 104 includes a computerized workstation comprising essentially a computer 114 and a telephone 115. Such work stations may be operated by first party or third-party vendor representatives that may be contacted by telephone to answer consumer questions or to conduct transactions by telephone.

Broker domain 103 includes a mail server 108. Mail server 108 includes a processor and memory containing all of the software and instruction required to function as a mail or messaging server. In one embodiment mail server 108 is hosted by the service provider and comprises a mail routing system for registered users of the service of the present invention. In another embodiment mail server 108 may be a third-party server connected to the network but outside of the domain of the provider.

Broker domain includes a multimedia router 109 supported by Internet backbone 109. Router 109 is capable of routing telephone calls. In this example, router 109 has connection to gateway 119 and telephone switch 126. Router 109 may route telephone calls placed at switch 126 from consumers dialing a provided number give to them be the service provider. Router 109 may route a call from a consumer operating telephone 124 to a service rep operating telephone 115. Telephone 115 is connected to switch 126 through gateway 119 via a phone line 118. Router 109 may be hosted within domain 103 or it may be a third-party hosted router leveraged to broker communications.

In one embodiment broker domain 103 includes a data search function part of SW 117 resident on server 105. The data search function may return data to consumers operating network-connected appliances such as appliances 120 through 125 with the exception of telephone 124. The data returned to consumers is presented and culled according to previously collected information from those consumers including tags representing selected preferences in product or service. In one embodiment the collected information includes the tags associated with preselected images sent to the consumers in a quiz process to build a search profile for finding products and or services.

In one embodiment the communications broker also includes a referral network function part of SW 117 that enables identification of clients referring users to one or more products and services of one or more than one vendor where those clients may be due commission or referral fees at the close of a transaction made on behalf of the particular vendor providing the product or service and in some cases the transaction process for acquisition of said products and or services. In the previous example of a real estate network, a client may be a user publishing the unique URL that directs referred users to property information of properties owned by sellers represented by the system. However, a client may have products or services and may just be an individual who refers another individual to the Website where the URL path the referred individual takes is validated by the system for the client who is registered with the system.

The sellers are analogous to vendors. In another example, a web store may offer web space to different and competing vendors to show case product and services where the facilitator or administrating entity of the store has pre-negotiated payment for offering the space and promoting the aggregate of content to a group of registered consumers and or to general public consumers. A group of consumers might be members of a shopping discount club, for example.

In one embodiment, the communications broker further includes a routing function for message and call routing. The system may route calls, for example, placed by consumers to generated telephone numbers previously provided to them through previous interaction with the broker such as at a website hosted by or otherwise monitored and at least partially controlled by the broker. The routing, referral, and data search functions are supported by the appropriate infrastructure including network nodes and gateways and telephony infrastructure including routers and switches. Seamless integration between the telephone network, such as a public switch telephone network (PSTN) and the data network (Internet) make tracking communications by plain old telephony endpoints plausible.

In general use of the present invention, a client (not illustrated) may register for brokering services through website 116 on web server 111. The client may be assigned a portal address, obtain an email or messaging account with the service, and may obtain a unique universal resource locator (URL) address linking to a site showcasing products and or services. The client publishes the URL using social media, email, brochures, or other methods. Client information including unique URL (client identifier) and product/service/vendor data may be stored in data repository 106. In one embodiment the client is redirected to server 105 during the account registration process. In one embodiment the client may be vetted and qualified before being accepted by the brokering service.

The brokering service may use the search function to help drive consumers such as those operating appliances 120 through 125 to client-referred products or services. In this process the broker may collect information from consumers through an interface served to consumer appliances over the network. In one embodiment this is part of a registration process for the consumer or “user” to practice the invention. In another embodiment no consumer registration is required. In one embodiment the consumers are organized in formal user groups that are registered as a group with the brokering services. The information collected may include typed answers to questions and instances of user selection of pre-presented images associated with text, the selection generating a tag associating the choice of image with particular attributes of a product or service.

The brokering service may use the referral network function to track transaction activity and account in real time for any fees resulting from transactions that are to be paid to clients of the service from vendors whose products and or services were sold to consumers accessing through the brokering system. Fees may include commissions, referral fees and residuals.

The brokering service may use the routing system to connect consumers to client referred vendor representatives by telephone over a telephony infrastructure such that the vendor is alerted that a fee may be due upon transaction occurrence and where the sessions may be recorded and archived for internal use in accounting and other processes. In one embodiment, the search function is performed to help drive potential consumers to client-referred products and services. The other functions launch when a consumer has received search results including client links and has selected a client link and activated a contact option associated with the client URL.

A listing agent (client) in real estate may, for example, list multiple properties for sale, the current owners considered vendors in this example. The search function leverages information and tags obtained from a consumer base of users to cull available property types and price ranges to those users' preferences. A consumer browsing through search results may select a link to a property listing that is associated with a client URL. The consumer lands on the client URL and may be monitored for activity. The routing function may launch when the user clicks on a live contact link to make a telephone offer to the agent, for example. The routing function may actually route the telephone portion of a pending session and may control whether the phone call will be completed to the agent. The agent might be a client in one aspect where the client is paid a referral fee for driving potential buyers to their URL, in this case to the service.

A client may also be a host to agents that are considered vendors of multiple properties. The hosting client, in this case the brokering service, would receive a fee for each lead materializing in a home sale.

The vendors may provide contact information for live representatives assigned to the products and services referred by the client. In one embodiment the vendors maintain their own checkout services and may also conclude transactions over the plain old telephone. The system aids the client by intervening in a pending transaction to affirm any prior referral fee or commissions fees agreements between the client and the vendor before the brokered communications session is established between a potential buyer and the vendor representative. Upon close of a transaction, the vendor may pay more readily due to prompting. The broker may aid the vendor in separating direct orders not requiring payment of a fee or commission from orders of those referred through the client. More detail about the way the system is integrated is provided later in this specification.

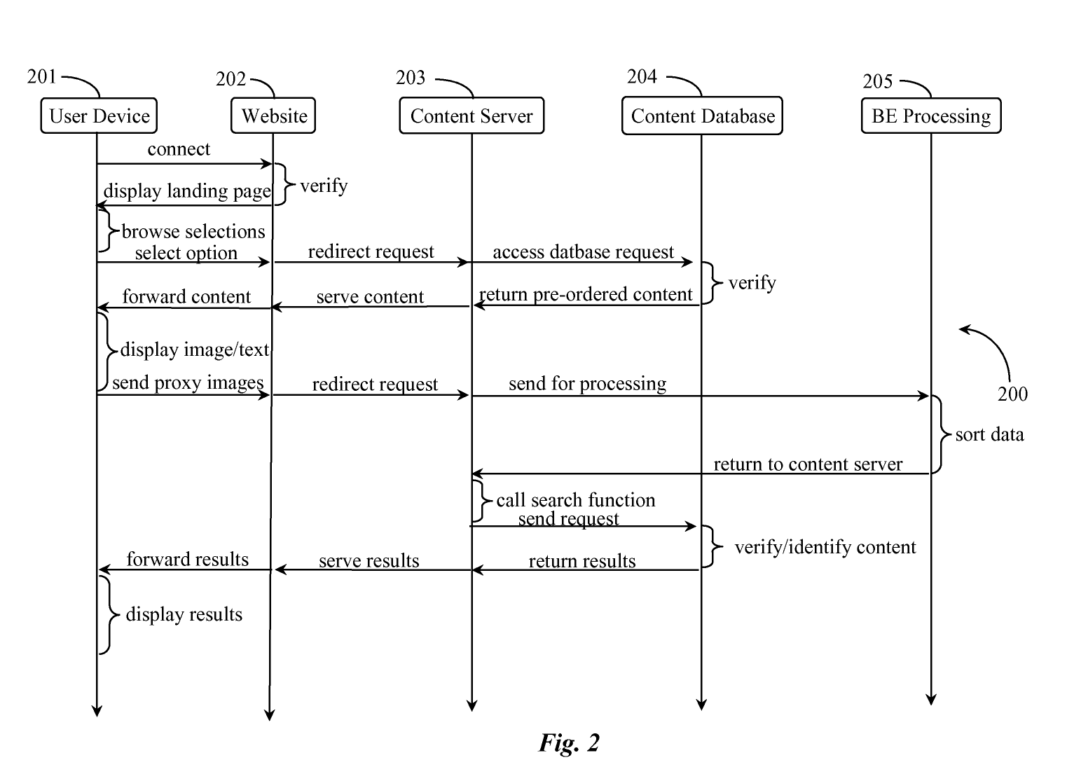

FIG. 2 is a sequence diagram 200 depicting interaction between a user and system components relative to building a search profile for the user. As described further above, a consumer or user operating a network capable appliance or device 201 may connect to a website 202 to obtain services. Website 202 may require user registration and authentication to verify the consumer may receive services. The website landing page displays for the accessing consumer. The landing page may include one or more selectable options.

After browsing options on the landing page, the user may select an option such as look for homes. The brokering system has previously linked the selected option to an automated data collection process running on a server such as server 105 executing SW 107 of FIG. 1. In this example, WS 116 is functioning as a proxy and redirects the user to the content server, such as content server 203. The server accesses the content from a content database 204, verifying the source of the request before completing the process. The pre-ordered content is passed to the content server and back to WS 202 where it is forwarded to the requesting consumer, the website functioning as a proxy. In one embodiment the website may connect the user to the content server and drop out of the loop completely.

Upon selection by the user of an option to look for homes, for example, the website may send an interface start page to the user's browser that displays quiz content including images with selection boxes for selection by the user. The images and text are displayed on the user's access device screen for selection and text input if required. The interactive quiz includes content displayed for the user and selection or check boxes next to content enabling the user to “mark as selected” specific images presented. For example, the user may answer a short questionnaire to gain basic information.

The system may send multiple images to the user the images depicting a variety of features and other attributes that may be directly or even loosely associated with a product. For a property with a home on it, the images might show different architectural features, interior features, exterior features, landscape features, and like that a home buyer might be interested in. The images are pre-selected by the broker and the theme of or feature in each image that may be relative to preferences of the consumers who look at them. If a served image is selected by a user the documented theme or features in the image are attributed to desires of the user for a new home and property. For example, a scenic ocean view, selected by a user might indicate a preference for coastal properties thus helping to cull listings from a larger pool of listings. When the user selects images, tags associated with those images are retrieved to provide the content associated with the selected images.

The data collection period may vary in length and scope by the type of products or services connected to the system. For a consumer looking for a home for sale, the displayed content may be browsed through by the user making selections of images in accordance to what attributes those images present that are preferred by the consumer in the eventual product such as a new home for example. In one embodiment the process of “quizzing” the user may be performed off line with the results of interaction stored in the cache memory on the user's appliance or device.

Once the process is finished, the content and tags associated with selected images are uploaded to content server 203. In one embodiment the data upload is sent to a back end processing server 205. Server 205 may employ an algorithm to sort the uploaded data for use including identification of attributes associated with tagged images. Attributes may include hard product features and lifestyle preferences indicated in the tagged images. The sorted and processed data may be returned to content server 203. Server 203 calls a search function adapted to use all of the processed data as a search profile. In this example the search is conducted within the content database 204. Content database 204 contains all of the client and vendor data that might be matched to during the search process.

The search results may be ranked results according to percentage of match to the attributes in the search profile. The results are returned to content server 203, which in turn serves the results to website 202. Website 202 forwards the results to the user device where they may be displayed for interaction. Results may include images text and links to vendor URLs that display the resulting products and that provide contact options for the user to interact live with a representative of a particular product or service returned in the search results that the user is interested in. The results may, for example, include real estate properties that match attributes associated with images tagged by the user during the quiz process. Clicking on a listing, for example, may take the user to a listing agent listing the property along with other properties assigned to the agent for selling.

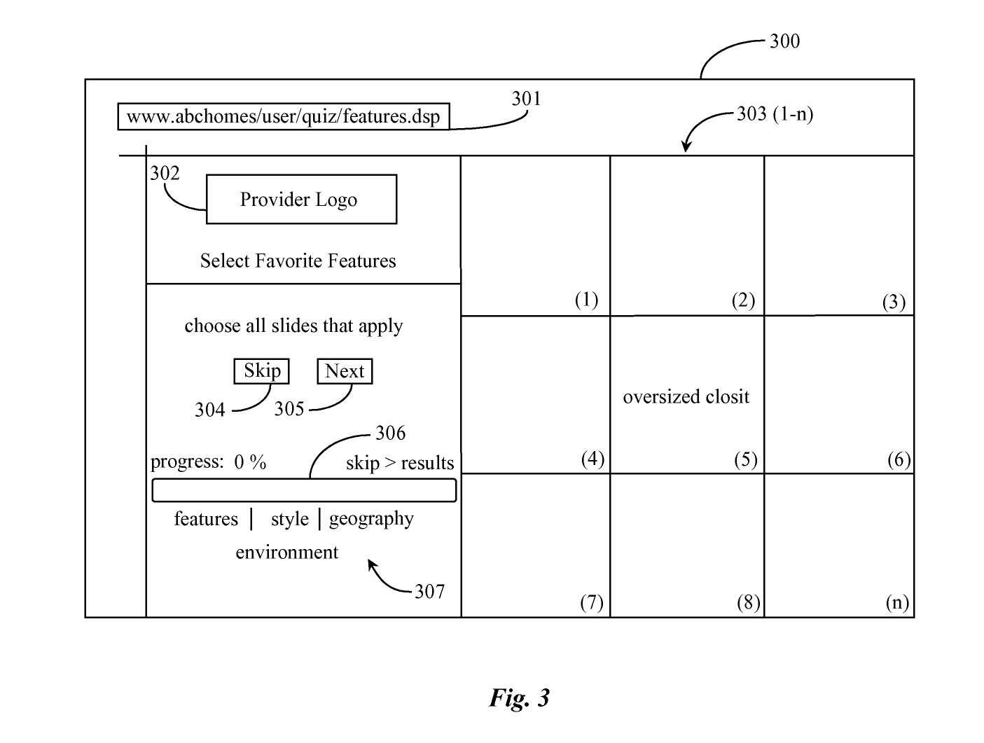

FIG. 3 is an exemplary screen shot of a user interface 300 for quizzing a user in building a search profile to search for available homes at a real estate website. Using the above example of a real estate website, a user may be quizzed in order to build a search profile that is suitable for culling a results list to properties the user will most likely be interested in. In this way the system of the present invention is tailored toward the business of real estate. However, this should in no way be construed as a limitation of the present invention.

The system of the invention may be employed to broker communications between consumers and a wide variety of other sales business like insurance, hotel booking, car rentals, vacation resorts, etc. The system may be used in a retail where a client may refer users to several vendors' products and services and may receive referral fees or commissions or residual payment for helping to move vendor products and services.

Interface 300 may be served to a consumer visiting a real estate website for example. The user may select an option “look for homes” to cause interface 300 to be served and displayed. In this example, the interface is browser based and includes a navigation bar 301 depicting the address of the URL of the provider in this case ABC Homes. Interface 300 may include a provider logo 302.

In this example interface 300 includes a display of images 303 (1-n). Images 303 (1-n) are served and displayed in interface 300 for the user to browse and select. There may be text instruction visible in interface 300 that informs the consumer that they are undergoing a quiz to build a custom search profile to use to find listings that the user will be more interested in reviewing. The user is prompted or otherwise instructed in interface 300 to choose all slides (images) that the user desires to include in the search for homes. A button 304 for skipping a slide is provided as well as a button 305 for selecting a next page of slides.

Interface 300 may include a progress bar 306. Progress bar 306 may depict the overall progress in building a consumer's custom search profile. In a search function adapted for real estate, there are essentially four main categories 307 the consumer interacts in before the profile is complete. These are features (home features), style (ascetic and architectural features), geography (areas to include in search), and environment (urban, rural, warm, seasonal). Progress bar 306 includes a percent indicator of how much progress across the four categories has been made. An option to skip directly to results is provided in case a consumer does not want to fully complete the quiz process. The granularity with which the results will match user preferences depends in part on how much information the consumer provides in the quiz process.

In this example, there is no progress yet as images 303 (1-n) may be the first set of images served. The set of images is relative to the “feature” category as evidenced by image 303 (5) label “oversized closet”. One or more questionnaire type forms or input fields may also be presented before images intermittent to image presentation or after image presentation. Instructions and help options may also be provided in interface 300.

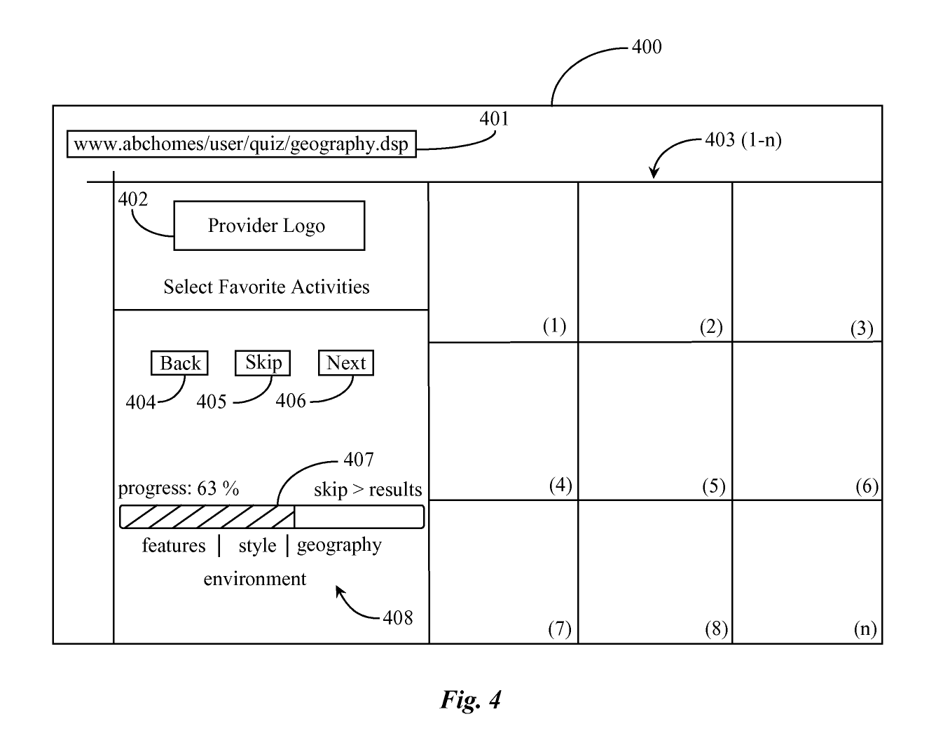

FIG. 4 is an exemplary screen shot of another view and state of interface 300 of FIG. 3. In this example, the consumer is further along in the quiz process as indicated by progress bar 407 showing 63% complete. This view and state of the interface is labeled interface 400 although it represents another position in the quiz process. Navigation bar 401 depicts the current category as geography. A back button 404 for revisiting previous sets of images or forms that were already populated by the consumer is provided within interface 400. A skip button 405 is provided for skipping images and a next button 406 is provided to call a next set of images or other in-line components like a set of input fields for answering questions.

In this embodiment, the category is geography. Images 403 (1-n) may depict various scenic geographic views such as coastal scenes, heartland scenes, mountainous scenes, lakeside scenery, and so on. The consumer chooses the images that best suit the consumer's desires for the kind of geographic surroundings the consumer wants to live in. While the depicted content of images 403 (1-n) may not directly relate to a structure (house) or feature of a structure, selection of one or more of the images sheds light on geographic preference, which is an attribute of every listing available through the site. Therefore high matching to geographic preferences of the consumer is apparent in the top listings returned in the search result.

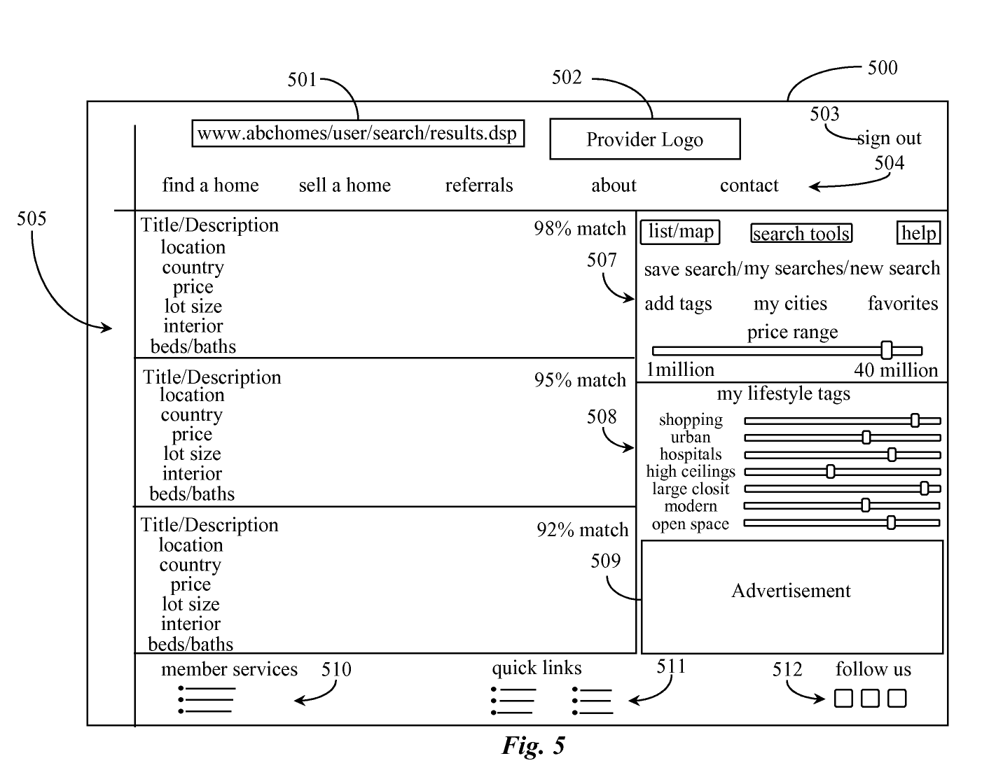

FIG. 5 is an exemplary screen shot of an interface 500 presenting search results organized according to user preferences. After the quiz process is completed for a user, the system performs a search of one or more data repositories holding available real estate listings that are assigned to a registered client such as a listing agent. Interface 500 includes a navigation bar 501 showing the URL of the results page. Interface 500 includes the provider logo 502. Interface 500 includes an option 503 for signing off of the service.

Search result interface 500 may include links 504 to other sections of the website including, from left to right, “find a home”, “sell a home”, “referrals”, “about”, and “contact”. Search result interface 500 includes returned real estate listings 505 with each result indication the percentage of match to the consumer profile. Each listing includes Title/Description, location, country, price, lot size, interior views/description, and number of bedrooms/bathrooms. A consumer may click on any listing to jump to a URL hosting the listing and assigned to a registered client of the service. Results list 505 may be scrolled through in typical fashion with additional listings loading after others are viewed. Controls may be preset to order how many results to include in a window. Views may be selected such as list view, image view, map view, and so on.

Interface 500 further includes a custom tools panel 507 including a list/map option, search tools, and a help button. Options for saving a previous search/accessing saved searches/and launching a new search are similarly provided in tool panel 507. Also provided is a price range tool for a consumer to set the maximum level of price for returned listings. Other general constraint tools and filters might also be utilized. Interface 500 includes, in one embodiment, a tools panel 508 containing level controls for adjusting various lifestyle tags created by the consumer during the quiz process.

The consumer might move the bar associated with a tag left or right to adjust its importance in the search process. The actual tags may represent images previously selected in the quiz process. Those tags depicted in tools panel 508 are just one example of a tags list that may be presented for consumer refinement. Adjustment of these importance levels may override levels previously derived through analysis of the quiz data uploaded to build the search profile for the consumer. Interface 509 includes an advertisement 509. Other links to other services might be provided such as links to members' services 510, quick links 511, and links 512 to social interaction pages where consumers may follow the provider company.

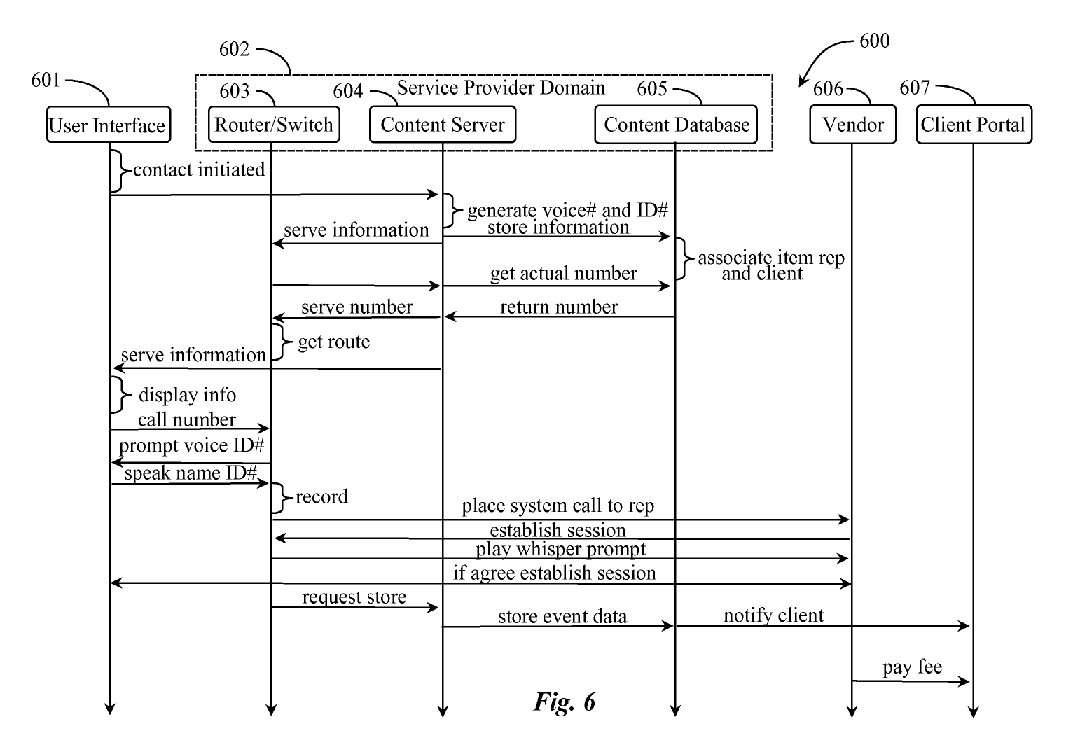

FIG. 6 is a sequence diagram 600 depicting interaction between a user and system components relative to tracking and routing a user inquiry into a product or service. In one embodiment of the invention, the provider of the communications brokering service may monitor consumer actions with search results and may further detect attempt by consumers to contact a live agent, for example with the possible intent of transacting. In this event the system may further route the consumer to a destination including the live agent and may be authorized as a third party broker that may complete the call request to the live agent for the consumer or not based on criterion pre-established between the vendor and client of the service relative to referral fees or residuals owed upon completed transactions.

A service provider domain 602 is depicted in this diagram and includes a router or telephone switch 603, a content server 604, and a content database 605. These components are analogous to those of the same description depicted in the architecture of FIG. 1 namely, server 105, repository 106, and router 109. Referral tracking only launches if a consumer that was served results has navigated to a listing associated with a client URL, for example, and attempted to contact a live agent representing the vendor. In a preferred embodiment the referral fee is vetted when the user has navigated to the unique URL assigned to the client.

A consumer operating through a user interface 601 is assumed to be on a URL associated with a product or service and has initiated contact. A “virtual” contact button for “calling a representative” of an item or service is provided by the service provider on client URLs next to appropriate products and services represented and which the consumer is attempting to call about. Once the consumer activates a call button, a request is sent to content server 604, the request including the product or service identification the consumer is calling about and the identification of the vendor and the client. As for the client, each may be assigned a unique URL by the system that the client publishes to consumers using a variety of methods such as mass email, social media, posts, etc.

The call request goes to the contact server 604. At content server 604, a unique telephone number is assigned to the consumer for the user to call. The number may, in one embodiment, be retrieved from a database of available numbers. In one embodiment the number is generated and activated only once when the consumer calls the number. The content server also generates a unique identification number for the consumer to use at a later point in the process. The server stores the information in content database 605 in association with the client URL and actual contact information (real destination number) and identification of the item/service of the inquiry and the name of the rep handling the call, if available.

Content server 604 serves the generated telephone number and identification number to the router in a request for the router to retrieve the route to the actual destination number. Router 603 may call content server 604 to get the actual contact number representing the routing destination number. Content server 603 may retrieve the number from the content database and may serve the number to the router. The router may then get a routing path for the expected call.

In the mean time, content server serves the “virtual” telephone number and identification number to the consumer interface 601 and the information is displayed on screen for the consumer. The consumer calls the virtual number using the same or another device executing a telephony voice call through dialing software application or a standard telephone device. The number is answered by router/switch 603. A voice application may be leveraged to serve a voice prompt to the consumer asking the consumer to state his or her name and enter the identification number previously served. The application may record the consumer's response.

The virtual telephone number is matched to the actual destination number the router has routing information for. The switch may open a connection to the actual telephone destination number such as by placing a system call to the agent assigned to that number. A session is established between the switch and the rep when the rep answers the call. The system may then play the recorded information in a prompt to verify the status of the consumer as being referred, and to confirm to the rep the responsibility of flagging the interaction for referral fee due upon a completed transaction.

The system may play a whisper prompt with the consumer on the line the prompt only heard by the agent. In another embodiment the system and agent are connected and the consumer is on hold at switch 603 until the agent accepts the terms of the call. At this point the router/switch may connect the agent and the consumer. There may be a variety of ways to accomplish the session between the agent and consumer with varying control over the session given to the third-party service provider. The system may continue to monitor and record the session if permitted by the parties.

The router/switch may request the content server to store the information in content database 605 for latter accounting or analysis. In this process the content server may also notify a client 607 identified as the client associated to the product or service subject to the interaction event using email, post, or messaging service. Upon transaction occurring, the vendor may pay the client whatever fees are due. It may be that the consumer does not close a transaction at the first telephone interaction. In any case, the vendor is made aware that the consumer was referred and if closed results in referral payment to the client. Thus the event is flagged at the beginning of the transaction process.

All of the interaction described in this embodiment is automated with the exception of the dynamic live interaction between the consumer and the rep. It is important to note herein that part of the motivation for becoming a client of the service is having the organization and accounting for each potential transaction and having referred products and services presented to special groups of consumers or to consumers in general through provided web presence in the form of client URLs assigned to registered clients. Motivation for the vendor to participate in a referral arrangement through the service provider may be the optimization in driving consumers to products and service that are more likely statistically to be purchased giving the high matching percentages to the previously revealed consumer preferences. The advantage is an economic advantage in that time is saved and when items are presented the vendors may have a higher expectation of a successful conclusion.

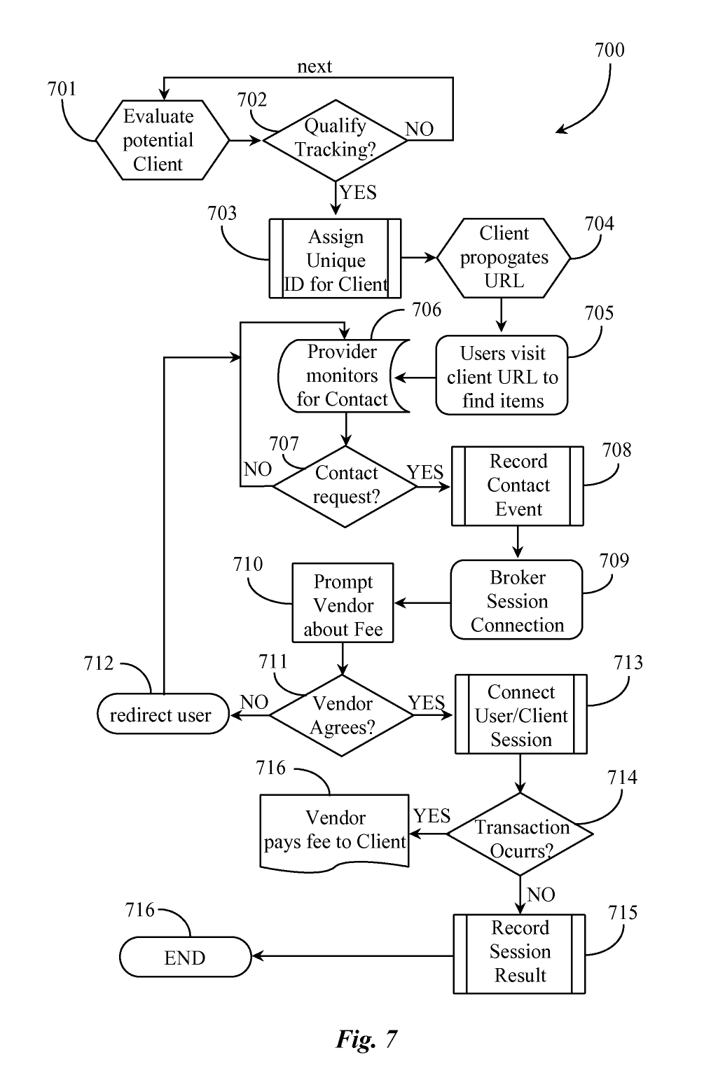

FIG. 7 is a process flow chart 700 depicting steps for tracking a client and brokering communications on behalf of the client. At step 701 a client may be evaluated for tracking services. A client may or may not represent a business entity that sells vendor products and or services for commissions or referrals or through some other monetary arrangement. It is determined at step 702 whether the client qualifies for tracking services. If a client does not qualify for tracking the process may loop back to evaluate a next client for tracking services.

If it is determined that the client qualifies for tracking services in step 702, the client is assigned a unique identification at step 703. In one embodiment the unique identification is a universal resource locator (URL) that the client may distribute to showcase vendor products and services the client refers users to. In the example of real estate, the client URL may showcase listings of available properties assigned to a real estate broker agent. The assigned URL uniquely identifies the client to the system.

In step 704 the client may disburse or distribute the unique URL to potential home buyers and may otherwise publish the URL. In step 705 the user navigates to the client URL to browse and find items or services, in this case homes. In one embodiment the URL is given to the client by the provider and the client uses it as a sales web space. The service provider monitors visitor traffic on the site for instances of activation of a contact option provided for visitors to open a voice connection with the client or a representative associated with a vendor the client is referring.

It is important to note herein that in one embodiment the users or “consumers” that visit the site include those that visit the site as a result of clicking on a search result served by the provider of services (communications brokering system). It may be those consumers who are tracked for referral fees rather than those who have navigated onto to the site of their own accord and were not referred by a client.

The provider may track all visitors for contact attempts or just visitors that were “referred” to the URL by executing their client URL. At step 706, the communications broker “listens” for any contact attempts. At step 707 it is determined whether or not a request for communication has been activated by a consumer activating a voice contact option. If it is determined that no attempts have been made in step 707, the process may resolve back to monitoring step 706. If the communications broker determines a contact request has been launched by a consumer visiting the URL, the contact request event is recorded in step 708.

The contact request is a voice request that may be routed by the broker over telephony infrastructure. Step 708 may also include notifying the client of the URL about the contact session and may include the event data associated with it including identification of the parties of the communication and of the items and or services negotiated during the communication session or otherwise the subject of the communications session.

The actual process of routing the request for voice contact is explained in detail further above in this specification and includes matching of a “virtual” contact number served along with a unique ID number to the requesting consumer to an actual telephone contact number or “voice” destination address of the individual (client or vendor rep) charged with communicating with consumers about the item or service that is the subject of the request. The actual routing may involve opening a service connection on behalf of the consumer with the agent and then connecting the consumer with the agent after prompting the agent at step 710 to inform the agent that the particular consumer was a referral and that a referral fee may be due upon closing. In this way, the broker tracks referral fees for the client and vendor.

In one embodiment the prompt is a recorded voice whisper played at the beginning of a session when the agent answers the call. The client name, identification number, item or service of interest, and fee amount due upon closing of a transaction may be played in the prompt. The prompt may seek confirmation or general agreement by the called party to pay the fee upon transaction close. It may be determined at step 711 whether or not the called party (client, vendor) has confirmed or otherwise is amenable to recognizing the consumer as a referred user and that a fee of a particular amount will be due in case of a transaction. In one embodiment there may be a small fee whether or not a transaction actually takes place such as a small lead fee payable to the service for referring the lead to the client URL through the search result process.

If the vendor does not agree to the terms at step 711, then the brokering service that is controlling routing of the requesting consumer may redirect the consumer to another destination number such as an interactive voice response (IVR) system to hear a recording, or back to the client. There may be a statement that the current item or service of your inquiry is temporarily unavailable for routing.

If the vendor agrees or otherwise confirms the referral tracking process and fee payout requirements in step 711, the broker may connect the agent and consumer in session at step 713. The broker may also monitor the communications for evidence of a transaction. However, further monitoring of the session is optional and is not a requirement for practicing the present invention. If it is determined that a transaction has occurred between the referred consumer and the agent at step 714, the vendor associated with the subject (item/service) of the transaction pays the client at step 716.

It might be that the brokered communication does not result in a transaction at step 714. In this case, the brokering system may record the session results at step 715 to archive and preserve the communications thread for the client to follow up on later. It may be that, like real estate, for example closing takes some time and more than one subsequent negotiation and communications session. Other items or services represented might be transacted during the first session between an agent and referred consumer. In this case the recorded result would include a record of, or at least some evidence of the transaction. The process may then end for that consumer at step 716. The process may loop back to step 706 for other referred users whom are visiting client URLs.

It will be apparent to one with skill in the art that the brokering system of the invention may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

What is claimed is:

1. An automated communications broker comprising:
a server connected to the network the server including a processor and at least one data repository and software executing from a non-transitory medium on the processor, the software providing:
a network connection between at least one network-connected appliance hosting source data and the server;
a data search function returning data for service to the at least one network-connected appliance based on collected information including information gained from consumer selection of multiple presented images;
a referral network function identifying clients of the communications broker, consumers navigating from client URLs, and tracking events that are subject to fee disbursement upon transaction occurrence; and
a routing function routing calls placed by the consumers to numbers provided by the broker, the calls including unique identifying indicia associated to each call, the numbers virtual numbers representing the actual contact representative numbers, the actual numbers matched to the called numbers within the routing process, the indicia identifying products or services and the contact representative numbers.

2. The communications broker of claim 1, wherein the network includes the Internet network and any connected communications networks.

3. The communications broker of claim 1, wherein the presented images are pre-selected images that may be associated with text inquiries, the images served to the hosting appliance of the data source from which data is to be collected.

4. The communications broker of claim 1, wherein at least the aggregate of the data associated with the consumer-selected images is used to form a data search profile for the consumer operating the appliance hosting the source data.

5. The communications broker of claim 4, wherein the search profile is leveraged to initiate a data search of one or more databases on behalf of the consumer.

6. The communications broker of claim 1, wherein the referral network function registers one or more uniquely identified clients to the network, the clients referring consumers to marketed products or services and receiving from the transaction broker a universal resource locator (URL) unique to the client for consumer direction.

7. The communications broker of claim 6, wherein the referral network function includes an activity monitor, monitoring consumer attempts to contact a vendor from a client URL using a service engineered contact option.

8. The communications broker of claim 1, wherein the routing function generates a call destination path at the router based on matching a virtual contact number given to the consumer to a destination contact number associated with the vendor responsible for servicing the items/services subject to the request.

9. The communications broker of claim 8, wherein the routing function includes a voice prompt to the vendor rep or agent of the call, the voice prompt transparent to the consumer in the form of a prompt requesting confirmation of payment of a referral or other fee due to the client upon conclusion of a transaction.

10. A system collecting data from a data source connected to a network and serving media including text results and contact links back to a hosting appliance of the data source or to a another communications endpoint comprising:
a server connected to the network the server having a processor and at least one data repository coupled thereto and software executing from a non-transitory medium on the server the software providing:
serving over the network of one or more pre-selected images and associated text to the hosting appliance of the data source from which data is to be collected;
collection of data from the data source, the data pointing to tags indicative of any of the served images selected through computer input methods;
identification of tagged images;
lookup of additional data pre-associated with the tagged images;
formation of a data search profile from the aggregate of the data;
leveraging of the search profile to initiate a data search of one or more databases; and
serving the results of the data search including images, text, and links to the hosting appliance of the data source or to the other destination.

11. The system of claim 10, wherein the network is the Internet network.

12. The system of claim 10, wherein the served images depict pre-documented features or attributes directly or indirectly associated with a product and or service the consumer is interested in.

13. The system of claim 10, wherein the associated text includes at least one question with a text input field for accepting typed input for an answer.

14. A network-based referral system comprising:
a server connected to the network the server having a processor and at least one data repository coupled thereto and software executing from a non-transitory medium on the processor, the software providing:
qualification of one or more user-referring clients to be included in a pool;
generation of unique identification in the form of a universal resource locator (URL) for each qualified client in the pool;
storing the client URLs in a referral database along with vendor information;
identifying a client URL used by a consumer in navigation, the consumer browsing a search result list compiled previously and based on collected input from the one or more consumers;
monitoring consumer activity and listening for browser-based execution of a vendor contact attempt;
upon contact initiation, record the contact event data;
notify client of the contact event;
route consumer request;
prompt vendor to pay referral fee to the client;
upon agreement from the vendor to pay the referral fee, connect the consumer to the vendor in session.

15. The system of claim 14, wherein the network is the Internet network.

16. The system of claim 14, wherein the client is notified of a contact attempt associated with a client URL through email, messaging, or a post to a client accessible URL.

17. A system tracking leads over a telecommunications infrastructure comprising:
a server connected to the network the server including a processor and at least one data repository and software executing from a non-transitory medium on the processor, the software providing:
monitoring of consumer activity at a vendor site, the consumer arriving at the site as a result of execution of a client distributed URL identifying the client to the system;
detection of a request for live contact directed to a content database;
generation of a unique identifier and a virtual phone number for the consumer to use to dial for service, the unique identifier providing identification of a product or service subject of the requested contact event and the virtual telephone number matched in storage to an actual contact number associated with a representative charged with servicing inquiries about the product or service subject of the request;
serving the unique identifier and virtual phone number to a communications switch or router and to the user end device used to access the client URL, and displaying the data on the user's device screen;
generating a destination path at the router based on the unique identifier and match of the generated telephone number to the representative contact number;
upon dial of the generated number by the user, answering, prompting for, and recording the user's spoken name and spoken or touch tone input of the identifier;
sending the contact event data to the server;
matching the called number to the telephone number of the appropriate product or service representative and routing the call accordingly;
upon answer of the routed call, prompting the representative to agree to pay a fee prior to connecting the representative to the waiting consumer;
connecting the consumer to the identified representative contingent upon agreement to pay a referral fee if there is a transaction;
recording the connected session and storing the event data in the content database; and
serving or otherwise sending electronically, the contact event data back to the client for their records.

18. The system of claim 17, wherein the network is the Internet network.

19. The system of claim 17, wherein the client URL is previously assigned to the client and locates a website owned or otherwise controlled by the system.

20. The system of claim 17, wherein the client URL is distributed to potential consumers being referred by the vetted client.
